(19) United States
(12) Patent Application Publication
(10) Pub. No.: US 2013/0034105 A1
(43) Pub. Date: Feb. 7, 2013

(54) CASCADING ROUTING QUERIES

(71) Applicant: Jeffrey S. Wall, Dallas, TX (US)

(72) Inventor: Jeffrey S. Wall, Dallas, TX (US)

(73) Assignee: IntelePeer, Inc., San Mateo, CA (US)

(21) Appl. No.: 13/197,887

(22) Filed: Aug. 4, 2011

(51) Int. Cl. H04L 12/56

(52) U.S. Cl. 370/400

(57) ABSTRACT

The present invention relates to systems and methods for performing queries in a cascading logic routing grid comprised of an array of interconnected nodes and at least one root node. At a first root node, one or more adjacent nodes are selected to process a query. The selection is based on the capabilities of the nodes and parameters of the query. Once the nodes are selected, a query is transmitted from the first root node to at least one of the one or more selected nodes. Upon completion of processing the query, a response is received at the first root node from at least one of the one or more selected nodes. The response comprises specifications for routing data. Based on the specifications for routing data received in the response, routing instructions are formed at the first root node.

### TECHNICAL FIELD

The subject matter of this application is generally related to telecommunications. In addition, the subject matter of this application generally relates to performing queries in a logic routing grid or cascading logic routing grid.

### BACKGROUND

Telecommunication providers provide the service of routing calls among other services. Each provider may select from several carriers to route a call to a particular destination. When a routing path is selected or constructed based on cost, this is referred to as least-cost routing. In order to select the least expensive method for routing a call, a telecommunications service provider will perform queries on static information known by that provider. Based on the query results, routing instructions are constructed. Currently, only one node, or component, can he queried at any time and only static data is available at the query initiating node. Since the capabilities and routing paths vary between constructing of routing instructions, there is a need for dynamic querying based on changing information at the query transmitting node. There is also a need to query beyond one node or component to provide for more accurate routing cost calculations and routing paths and faster, more efficient routing.

### SUMMARY

The present disclosure relates generally to performing cascading routing queries in a logic routing grid. In an embodiment, the logic routing grid comprises a plurality of interconnected nodes, wherein each node has at least one capability. Each node may have capabilities that differ from other nodes. Further, the capabilities of the nodes are accessible by at least one of the nodes, such as a first root node that is adjacent to: the nodes. The method includes selecting, at the first root node, one or more nodes to process a query. The selection of nodes is based on the capabilities of the nodes and parameters of the query. Once the nodes are selected, a first root node transmits the query from the first root node to at least one of the one or more selected nodes. Upon completing the processing of the query by the one or more selected nodes, a response is received at the first root node from at least one of the one or more selected nodes. The response includes specifications for routing data. Based on the response, the first root node forms routing instructions based on the specifications for routing data received in the response.

In an additional embodiment, the query is performed in a cascading logic routing grid. The cascading logic routing grid comprises a plurality of interconnected nodes and at least one root node. Each node has at least one capability, such that the capabilities vary among the nodes. Further, the capabilities of the nodes are accessible by one or more root nodes adjacent to the nodes. In addition, a subset of the capabilities comprises information defining logical connections between the nodes. The method includes selecting, at a first root node, a first logical connection of one or more nodes to process a query. The selection is based on the capabilities of the nodes, the logical connections between the nodes, and parameters of the query. Once the nodes have been selected, a query is transmitted from the first root node to at least one of the one or more nodes in the first logical connection. Upon completion of processing the query, a response is received at the first node from at least one of the one or more nodes in the first logical connection, the response comprising a plurality of specifications for routing data. Based on the specifications of the response, routing instructions are formed at the first root node.

In yet another embodiment, a logic routing grid for performing routing queries is provided. The logic routing grid comprises an array of interconnected nodes and at least one root node, such that the root node is configured to initiate and resolve queries. Each node is associated with respective capabilities, and the capabilities vary among the nodes. Each of the nodes comprises a communication interface configured to communicate with other nodes and root nodes. Each node also comprises an engine configured to process queries. Each of the root nodes comprises an analyzer configured to analyze the capabilities of the nodes and parameters of a query to select one or more nodes for processing the query. A database configured to store capabilities associated with adjacent nodes is an additional component in each root node. In addition, each root node comprises a communication interface configured to transmit the query to at least one of the one or more selected nodes and to receive a response from at least one of the one or more selected nodes, such that the response comprises specifications for routing data. Each of the root nodes also comprises a compiler configured to form routing instructions based on the specifications for routing data received in the response.

### BRIEF DESCRIPTION OF THE DRAWINGS

The foregoing summary and the following detailed description are better understood when read in conjunction with the appended drawings. Representative examples are shown in the drawings. However, it is understood that the examples are not limited to the specific methods and instrumentalities depicted herein. In the drawings:

FIG. 1 shows a grid layout of an embodiment of a logic routing grid.

FIG. 2 illustrates a communication structure between a softswitch or legacy switch and a node.

FIG. 3 illustrates a communication structure between a softswitch and a node.

FIG. 4 shows a grid layout with subsets of nodes of an embodiment of a cascading logic routing grid.

FIG. 5 shows the contents of a query.

FIG. 6 is a flowchart showing a process for performing a query in a cascading logic routing grid.

FIG. 7 is a flowchart showing a process for performing a query using call routing digits in a cascading logic routing grid.

FIG. 8 is a flowchart showing a process for performing a query using subsets of nodes in a logic routing grid.

### DETAILED DESCRIPTION

It will be appreciated that the following description is intended to refer to specific examples of structure selected for illustration in the drawings and is not intended to define or limit the disclosure, other than in the appended claims.

The present disclosure provides methods and systems for routing and processing queries in a logic routing grid or cascading logic routing grid. Notably, the methods and systems provide means to query second tier (or higher) nodes removed from the initiating node. As a result, the querying node is able to construct routing instructions based on dynamic information. Further, the processing of the query across several nodes increases the speed of processing the query and receiving a query response.

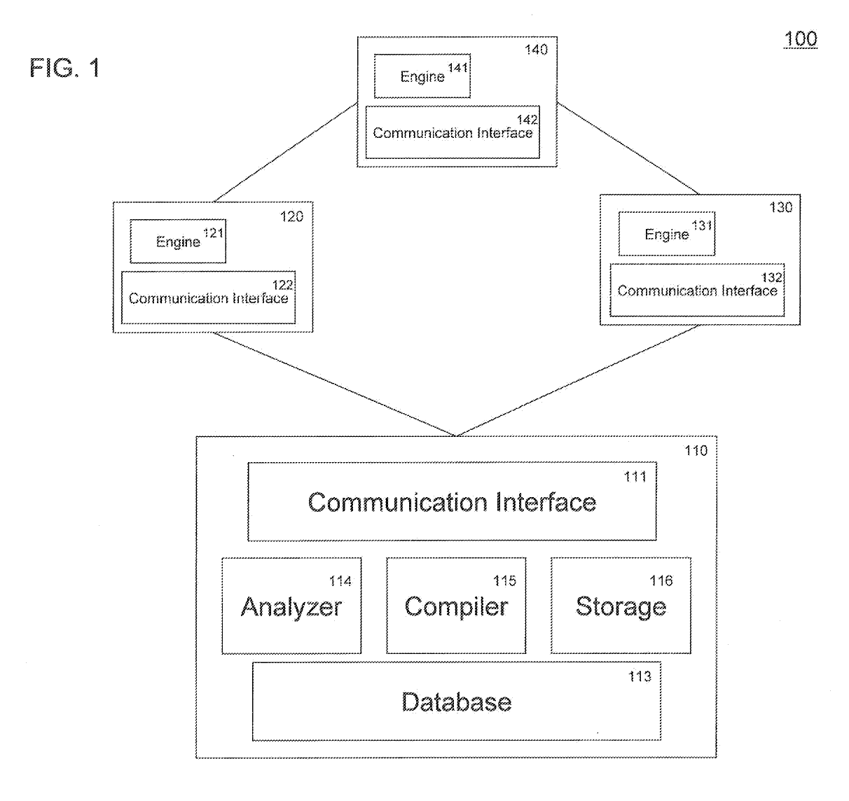

FIG. 1 is a block diagram of an example logic routing grid 100 for performing queries for routing data in a dynamic and cost-effective manner. In some implementations, the logic routing grid 100 includes a plurality of nodes 110, 120, 130, 140. In other implementations, there may be more nodes or fewer nodes than those depicted in FIG. 1. The nodes 110, 120, 130, 140 may be least cost routing servers, or part of a major trading area (MTA) jurisdiction for example.

By way of an overview, the available MTA jurisdictions include interstate, intra-state, local, and international. If a call is a cellular call, then the call would be within an intra or inter-MTA jurisdiction. If a call is a landline call, then the call would fall into the interstate, intra-state, local, or international jurisdictions.

One or more of the nodes, such as node 110, may be a root node comprising a communication interface 111, a database 113 an analyzer 114, a compiler 115, and optionally storage 116. The communication interface 111 is configured to allow for communication between root node 110, for example, and other nodes 120, 130, 140. Such examples of communication include transmitting a query from root node 110 to node 120 and receiving a response from node 120 at root node 110. A node may communicate using SCCP (Signaling Connection Control Part) User Adaption (SUA) Layer Protocol or Session Initiation Protocol (SIP), for example, when querying or communicating with other nodes.

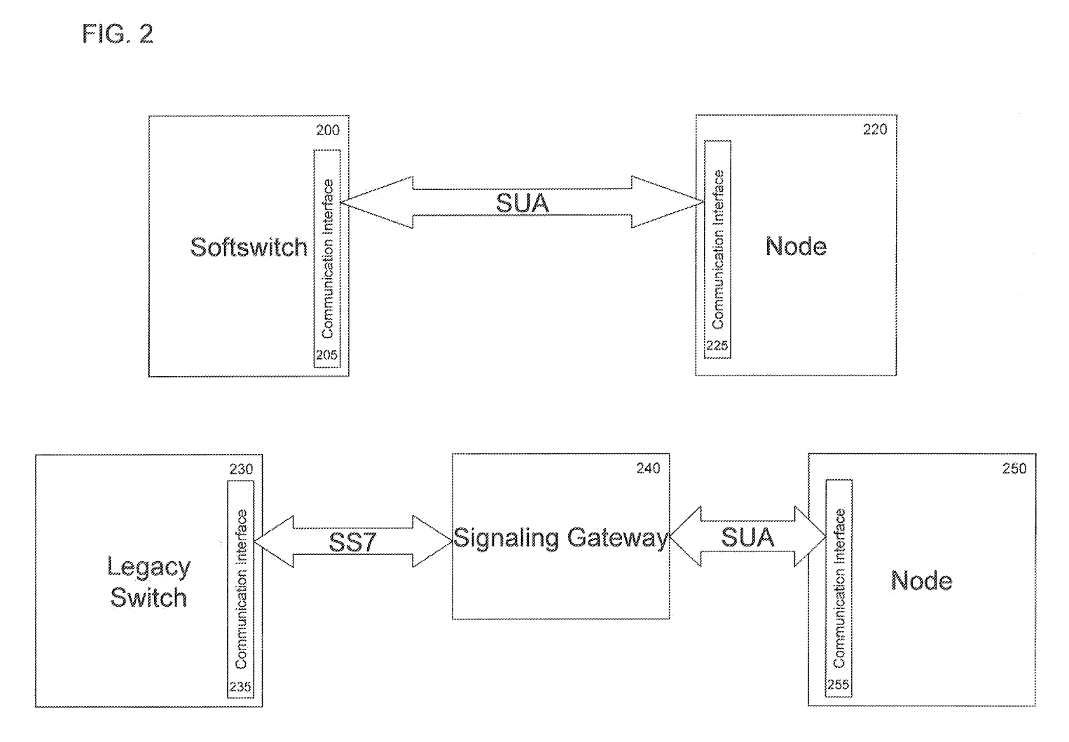

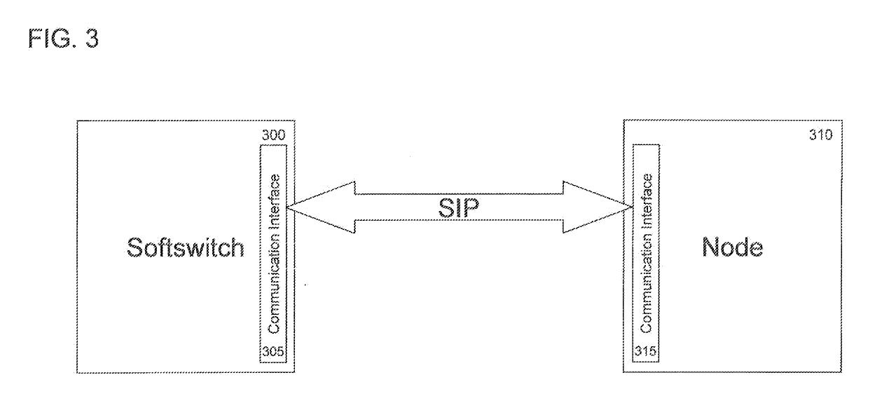

As shown in FIG. 2, if a softswitch 200 is present, then SUA transmission occurs between a communication interface 205 of the softswitch 200 and a communication interface 225 of the node 220. If a legacy switch 230 exists between the nodes, then the legacy switch 230 registers with a signaling gateway process (SOP) that runs on a signaling gateway (SG) host server 240 as shown in FIG. 2. Registration may be performed using Signaling System No. 7 (SS7), of which SCCP is a component, for example. Upon registration with the SG 240, the legacy switch 230 transmits data through a communication interface 235 to the SG 240, such that SUA transmission occurs between the SG 240 and a communication interface 255 of the node 250 as shown in FIG. 2. As shown in FIG. 3, if the transmission is sent via SIP, the transmission between a communication interface 305 of the softswitch 300 and a communication interface 315 of node 310 occurs without handshaking.

With further reference to FIG. 1, the analyzer 114 is configured to analyze the capabilities of adjacent nodes 120, 130 and parameters of a query used for selecting nodes for processing the query. The analyzer 114 stores and parses the capabilities of the adjacent nodes 120, 130 in the database 113. For example, the analyzer 114 may parse adjacent nodes to determine to which nodes to distribute the load of processing the query, which nodes store information or data requested in the query, or which nodes have the desired functionality requested in the query. The compiler 115 is configured to form routing instructions based on the specifications contained in the received query response. The compiler 115 is further configured to filter a list of carriers to only include those that are capable of executing the routing instructions.

In addition, the nodes 110, 120, 130, 140 may optionally include a routing engine for processing queries received at a node 110, 120, 130, 140. Further, each node 110, 120, 130, 140 may include storage 116 for storing data at a respective node that may be retrieved in response to a query, for example.

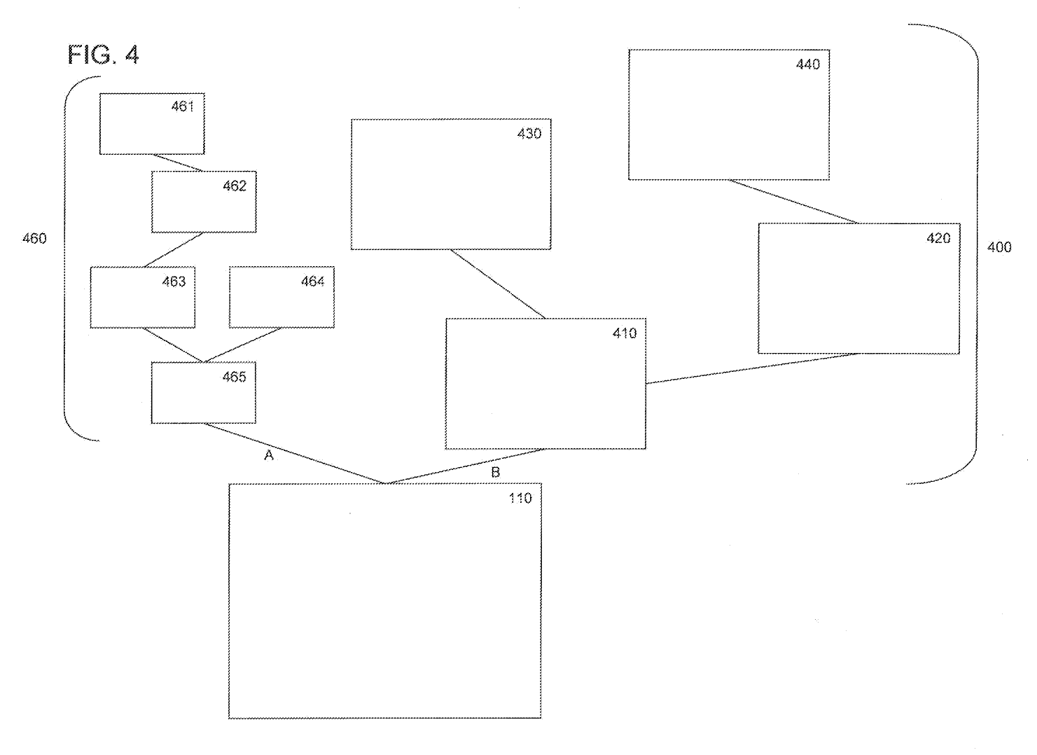

The nodes 110, 120, 130, 140 may also be interconnected. For example, node 140 has a logic connection to nodes 120 and 130 as illustrated in FIG. 1. Therefore, nodes 120 and 130 are aware of the capabilities of adjacent node 140. A node 110, 120, 130, 140 may also be connected to several subsets 400. 460 of additional nodes 410, 420, 430. 440 and 461, 462, 463, 464, 465 as shown in FIG. 4.

Each node 110. 120, 130, 140 has at least one capability, such as specifying available routing paths to and from that node, type of data stored at the node, location of data stored at the node, resources available for the node, carriers associated with the node, and whether the node is acting as a root node or a leaf node (i.e., nodes 120, 130, 140) for a particular query. The available capabilities may vary for each node 110, 120, 130, 140. In addition, the capabilities available for a particular node 110, 120, 130, 140 are accessible by other adjacent nodes or subsets 400, 460. Further, a subset 400, 460 of nodes may have its own capabilities. The subset capabilities account for the capabilities of the nodes 410, 420, 430, 440, and 461, 462, 463, 464, 465 within the subsets 400, 460. The capabilities may also specify how the subsets 400, 460 are logically connected to another node. For example, subset 460 is logically connected to root node 110 through logic connection A and subset 400 is connected to root node 110 through logic connection B which may be specified in the capabilities of the subset 400, 460. Thus, root node 110 may have knowledge of the subset 460 as represented by stored data in adjacent node 465 of the subset 460, without having direct knowledge of the capabilities of other nodes within the subset 460. In addition, cascading logic routing grids may be constructed from the connection information provided in the capabilities of a node.

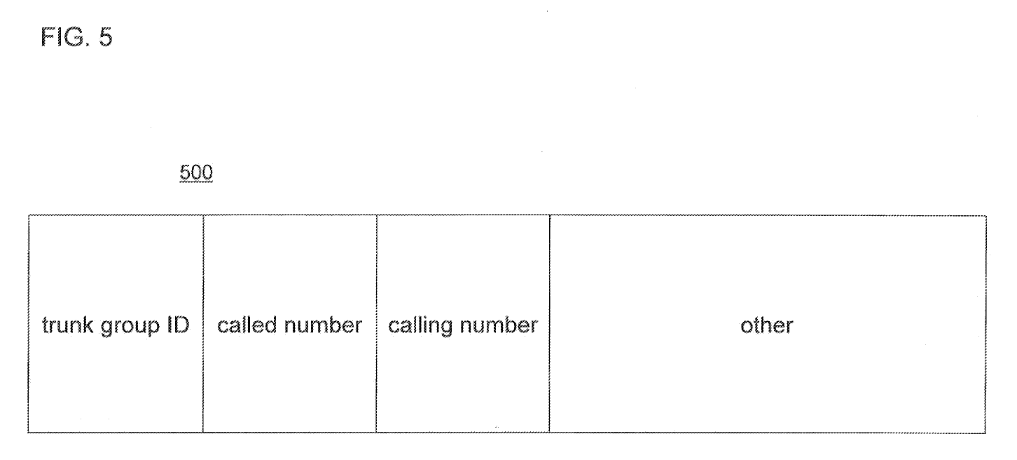

Referring to FIG. 5, a query 500 may be comprised of a source trunk group identifier, a called number, a calling number, and other fields for additional information. The other fields may include maximum forwards, a subject for the query, and an identifier for the type of data, for example. The maximum forwards field is a parameter that allows the sender to limit the number of nodes that can be traversed in order to determine the desired routing logic. For example, each node that receives an invitation message to process a query may decrement the value for the maximum forwards field, and a node that receives an invitation message with the maximum forward value set to zero will not forward the invitation to another node. The root node 110 receives a query 500 containing, at a minimum, a source trunk group identifier and the called number digits. Other call information such as call origination digits, routing number, and jurisdiction information may also be present in the query 500. The root node 110 stores all information received in the query in database 113. The source trunk group identifier and called number digits are extracted and used to determine whether an additional node should be interrogated. If the root node 110 determines that a node deeper in the connected nodes should be interrogated, received query information is forwarded to that node for further processing thereof.

As one example for a query, a node acts as a routing engine that receives a query from a root node requesting routing options for establishing and maintaining a communication session. The query may include signaling information that includes information related to the communication session. The node processes the query by identifying, through the use of parameters of the signaling information, carriers or nodes that are capable of handling the communication session. Further processing of the query may include the node ordering the identified carriers according to the cost each carrier charges for the communication session. The ordering of the carriers in a list based on cost constitutes a response to the query, which is provided to the root node.

By way of an example, a query may be directed to determining whether a looping condition exists to decide whether to stop routing a call that is looping. When calls are routed, a call looping condition may occur when the call is handed off to a subsequent service provider that is unaware of the path taken by the call to reach said subsequent service provider. As a result, the subsequent service provider may route the call back through a prior service provider that has already processed and forwarded the call. In this manner, the call may continue to be routed and re-routed indefinitely amongst several providers without ever reaching its destination, resulting in unnecessary routing and usage of network resources.

In order to stop a looping condition, a query containing the looping condition inquiry for a looped call is sent from root node 110, for example, to adjacent node 120, which may be a routing server. Node 120 extracts the calling and called number pair from the query and compares the calling and called number pair against a database of recent calls within the node 120 to determine whether the number of appearances of the calling and called number pair has reached a predetermined threshold. If the calling and called number pair has appeared a sufficient number of times to meet the predetermined threshold, a release message is returned to root node 110 as a query response to stop routing the call. If the calling and called number pair has not met the predetermined threshold of appearances, a response is returned to the root node 110 that a looping condition has not been detected and that the root node 110 should continue to route the call according to least cost routing table stored at the root node 110, for example.

By way of another example, a query may be directed to determining the jurisdiction of a call and routing that call appropriately. The root node 110, for example, is loaded with normal least cost routing information. Another node, such as one of nodes 120, 130, for example, is loaded with routing information for intra-MTA calls. In this example, node 120 is loaded with the routing formation for intra-MTA calls. If the call is a cellular call, then the root node 110 may forward the query to intra-MTA routing node, i.e., the node 120. If the call is determined to be an intra-MTA call, then node 120 will return a query response with appropriate routing instructions to node 110. If the call is an inter-MTA call, node 120 will return a continue response to the query that allows the root node 110 to make a routing decision based on the jurisdiction determination for the call. The jurisdiction may be interstate, intra-state, local, or international.

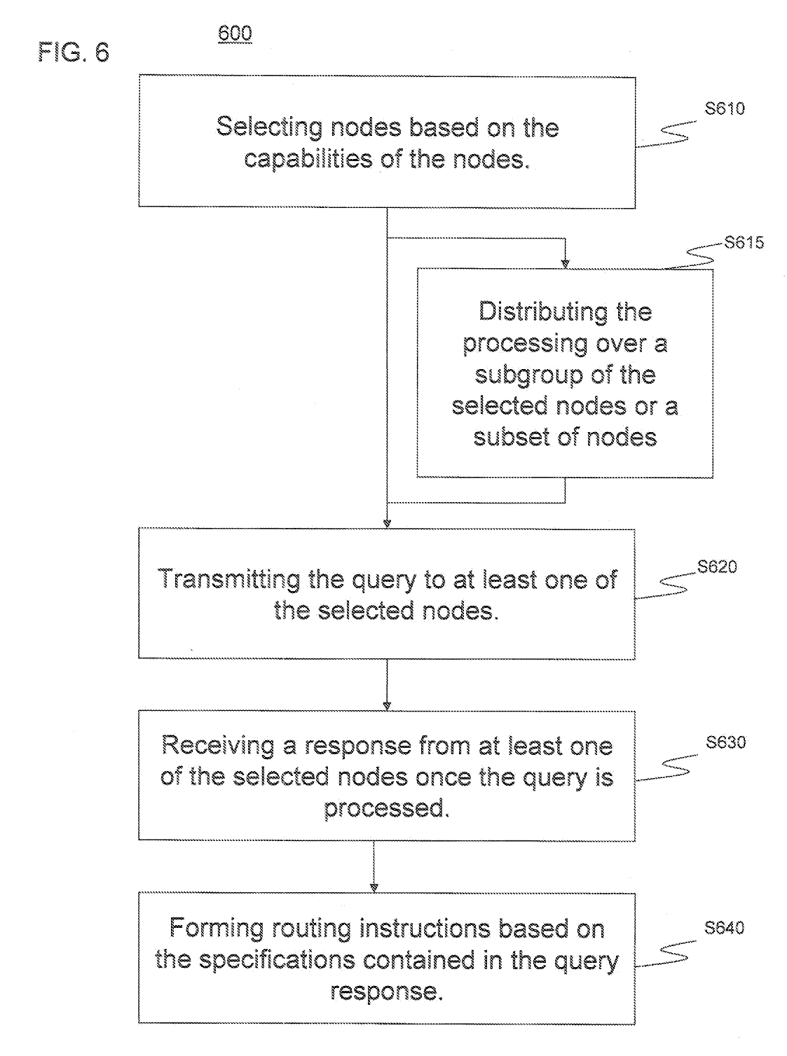

Now turning to FIG. 6, a flowchart showing a process 600 for performing a query in the logic routing grid 100 is provided. According to the process 600, root node 110, for example, selects one or more of adjacent nodes 120, 130 to process a query (S610). For example, the analyzer 114 may parse the capabilities of known nodes stored in the database 113. Although root node 110 is used to initiate the query, any node can initiate a query. The selection of nodes by root node 110 is based on the capabilities of the nodes known to root node 110. Root node 110 stores known capabilities and parameters of a query in database 113 and optionally in storage 116.

Since the processing of the query may be distributed across several nodes, root node 110 may distribute the processing of a query over nodes 120 and 130, or over a subset 400, 460 of nodes, for example, using SIP or SUA as illustrated in FIGS. 2 and 3 (S615). Root node 110 or one of the selected nodes 120, 130 may determine across which nodes to distribute the processing of the query. The node that determines over which nodes to distribute the processing of the query is referred to as the query distributing node.

In some implementations, the location of data in storage 116 of a node 110, 120, 130, 140 may also determine how the processing of a query is distributed across nodes 110, 120, 130, 140. Such distribution is based on the location of the data stored among nodes 110, 120, 130, 140 in their respective storage 116.

Further, querying one node may prompt that node to query another node adjacent to it. For example, root node 110 may select node 130 to perform the query. Upon receiving the query, node 130 may then select adjacent node 140 to perform the query although node 140 was not selected by root node 110. Transferring the processing of the query from node 130 to node 140 on the processing of a query may be due to unavailable resources for processing the query at the selected node or the ability of another node or nodes or process the query more quickly than the selected node.

Once root node 110 has selected at least one of adjacent nodes 120, 130 to perform the query, root node 110 transmits the query to at least one of the adjacent nodes 120, 130 selected to perform the query through the communication interface 111 (S620).

Once the query is processed, root node 110 will receive a response from at least one or more of the selected nodes 120, 130 that received the query (S630). The response may contain specifications for routing data based on the results of the query. The root node 110 will form routing instructions based on the specifications for routing data received in the query response (S640). Constructing routing instructions may also include updating existing routing instructions based on the query response. The compiler 115 may construct the routing instructions, for example. Root node 110, or any of the nodes 120, 130, 140 that processed one or more portions of the query, may filter the available carriers to those which are capable of executing the routing instructions as specified in the query. The filtering of carriers may also be performed by the compiler 115, for example.

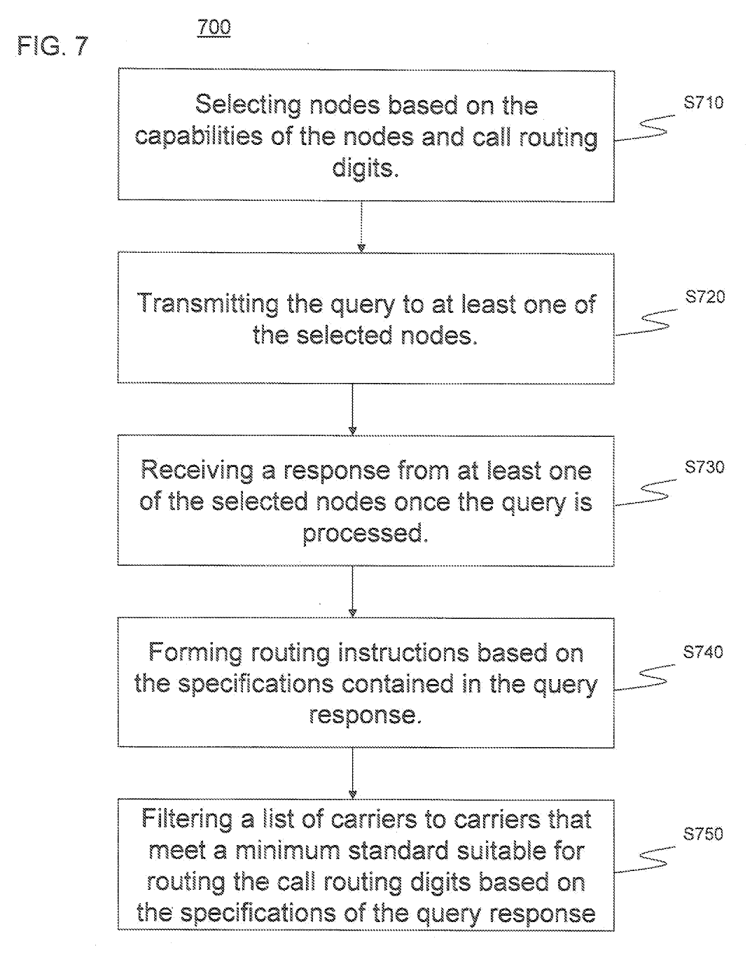

FIG. 7 illustrates a process 700 for performing a query using call routing digits in the logic routing grid. The call routing digits are contained in a query (S710). In this implementation, root node 110 may, for example, determine a set of corresponding nodes based on the set of call routing digits of the query instead of, or in addition to, the capabilities stored in database 113. Once the nodes are selected, the query is transmitted to the selected nodes using SUA or SIP as shown in FIGS. 2 and 3 (S720). Upon completion of processing the query, at least one of the nodes 120, 130 will return a response to root node 110 (S730). The response may contain specifications for routing data based on the query results. Root node 110 forms instructions based on the specifications for routing data provided in the query response (S740). Further, root node 110 may filter a list of carriers by determining which carriers meet a minimum standard suitable for routing the data with the call routing digits and the specifications contained in the query response (S750).

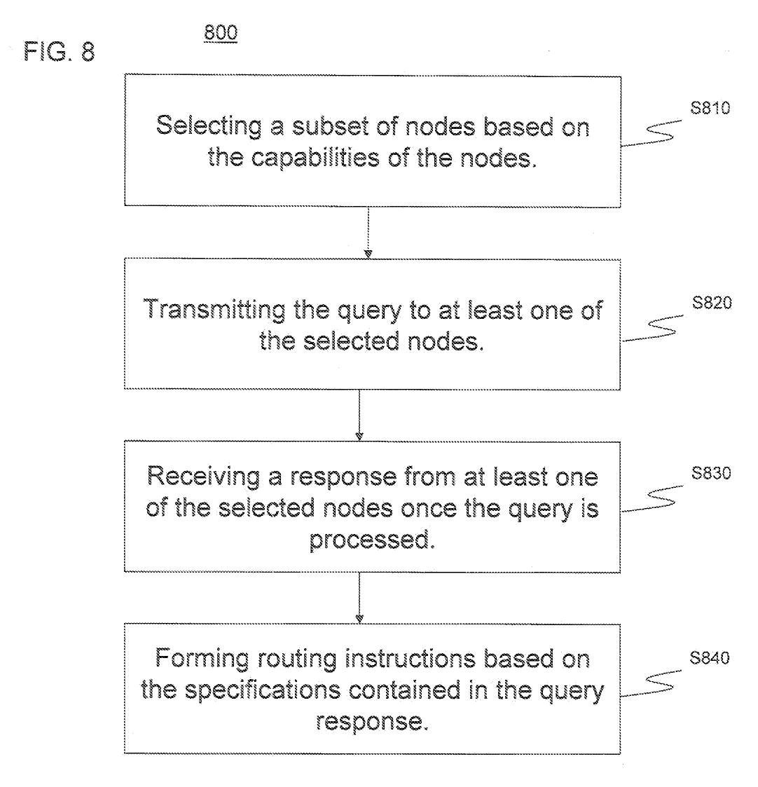

FIG. 8 illustrates embodiment of a process 800 for performing a query in the cascading logic routing grid. Root node 110 constructs a cascading logic routing grid comprised of nodes based on the logic connections specified by capabilities associated with known nodes (i.e., adjacent nodes) stored in database 113 (S810). For example, root node 110 may establish that subset 400 has a cascading logic routing grid of nodes 410, 420, 430, 440 and is logically connected to it via logic connection B. In addition, other adjacent nodes 120, 130 may form their own cascading logic routing grids. Once the cascading logic routing grid is determined based on the specified logic connections A, B, root node 110 selects a first logic connection A, B or at least one of the adjacent nodes 410, 465 of the cascading logic routing grid or at least one of the subsets 400, 460 of nodes to perform the query. The selection of logic connections A, B, adjacent nodes 120, 130, and subsets 400, 460 is based on the capabilities of the nodes 410, 420, 430, 440 and 461, 462, 463, 464, 465 or subsets and the parameters of the query. When the adjacent nodes 120, 130 or subsets 400, 460 are selected, the query is transmitted to at least one of the adjacent nodes 120, 130 or subsets 400, 460 connected to the selected logic connection A, B (S820). Upon completion of the processing the query, at least one of the adjacent nodes 120. 130 or subsets 400, 460 returns a query response to root node 110 (S830). Based on the specifications of the query response, the root node 110 forms routing instructions for routing data (S840). Further, the root node 110 may filer a list of carriers capable of executing the routing instructions.

Although the system and methods have been described in connection with specific forms thereof, it will be appreciated that a wide variety of equivalents may be substituted for the specified elements described herein without departing from the spirit and scope of this disclosure as described in the appended claims.

What is claimed is:

1. A method for performing routing queries in a logic routing grid, the logic routing grid comprising a plurality of interconnected nodes, wherein each node has at least one capability, wherein the capabilities vary among the nodes, and wherein the capabilities of the nodes are accessible by one or more root nodes adjacent to the nodes, comprising:
selecting, at a first root node, one or more nodes to process a query, wherein the selection is based on the capabilities of the nodes and parameters of the query;
transmitting the query from the first root node to at least one of the one or more selected nodes;
receiving a response at the first root node from at least one of the one or more selected nodes, the response comprising specifications for routing data; and
forming, at the first root node, routing instructions based on the specifications for routing data received in the response.

2. The method of claim 1, further comprising:
filtering, at the first root node, a list of carriers capable of executing the routing instructions.

3. The method of claim 1, wherein the first root node comprises a least cost routing server.

4. The method of claim 1, further comprising:
determining an additional node for distributing the query over the selected one or more nodes for processing the query.

5. The method of claim 4, wherein the additional node to which processing of the query is distributed is connected to a subset of nodes such that processing and:data are distributed across the subset of nodes.

6. The method of claim 1, wherein the selection of one or more nodes to process a query is further based on data stored at the nodes.

7. The method of claim 1, wherein the selection of one or more nodes to process a query is further based on a set of call routing digits contained in the query.

8. The method of claim 7, wherein selecting, at a first root node, one or more nodes to process a query based on a set of call routing digits, comprises:
determining a set of corresponding nodes based on the set of call routing digits.

9. The method of claim 8, further comprising:
transmitting the query to the corresponding nodes;
receiving a response, at the first root node, providing specifications for routing data from the corresponding nodes; and
filtering a list of carriers, at the first root node, by determining corresponding carriers that meet a minimum standard suitable for routing the call routing digits and the specifications contained in the response.

10. The method of claim 1, wherein the query is a query for determining a jurisdiction for routing a call, the method further comprising:
determining the jurisdiction that will handle the routing of the call based on whether a call is a cellular call or a landline call; and
wherein if the call is a cellular call, the jurisdiction for the call is at least one of a cellular intra-major trading area and a cellular inter-major trading area, and
wherein if the call is a landline call, the jurisdiction is at least one of an interstate, intra-state, local, and international major trading area.

11. The method of claim 1, wherein each of the nodes comprises a routing engine or a least cost routing server.

12. The method of claim 1, wherein a capability of each node from a subset of the plurality of interconnected nodes specifies a logical connection among the subset of nodes.

13. The method of claim 12, further comprising:
constructing, at the first root node, a cascading logic routing grid based on the logical connections.

14. The method of claim 1, wherein a capability specifies at least one of available routing paths, location of stored data, resources available at a node, carriers associated with a node, and whether a node is acting as root node or a leaf node for a particular query.

15. The method of claim 1, wherein forming routing instructions comprises updating existing routing instructions based on the response.

16. A method for performing routing queries in a cascading logic routing grid, the cascading logic routing grid comprising a plurality of interconnected nodes and at least one root node, wherein each node has at least one capability, wherein the capabilities vary among the nodes, and wherein the capabilities of the nodes are accessible by one or more root nodes adjacent to the nodes, wherein a subset of the capabilities comprises information defining logical connections between the nodes, comprising:
selecting, at a first root node, a first logical connection of one or more nodes to process a query, wherein the selection is based on the capabilities of the nodes, the logical connections between the nodes, and parameters of the query;
transmitting the query from the first root node to at least one of the one or more nodes in the first logical connection;
receiving a response at the first root node from at least one of the one or more nodes in the first logical connection, the response comprising a plurality of specifications for routing data; and
forming, at the first root node, routing instructions based on the specifications for routing data received in the response.

17. The method of claim 16, wherein selecting one or more nodes to process a query comprises:
distributing processing of the query over one or more nodes based on the capabilities of the nodes.

18. The method of claim 16, wherein the selection of one or more nodes to process a query is further based on data stored at the nodes.

19. The method of claim 16, further comprising:
filtering, at the first root node, a list of carriers capable of executing the routing instructions.

20. A logic routing grid for performing routing queries, comprising:
an array of interconnected nodes and at least one root node, the root node configured to initiate and resolve queries, wherein each node is associated with respective capabilities, wherein the capabilities vary among the nodes,
each of the nodes comprising:
a communication interface configured to communicate with other nodes and root nodes:
an engine configured to process queries;
each of the root nodes comprising:
an analyzer configured to analyze the capabilities of the nodes and parameters of a query to select one or more nodes for processing the query;
a database configured to store the capabilities associated with nodes adjacent to the respective root node;
a communication interface configured to transmit the query to at least one of the one or more selected nodes and to receive a response from at least one of the one or more selected nodes, the response comprising specifications for routing data; and
a compiler configured to form routing instructions based on the specifications for routing data received in the response.

21. The logic routing grid of claim 20, wherein the compiler is further configured to filter a list of carriers capable of executing the routing instructions.

22. The logic routing grid of claim 20, wherein the analyzer is further configured to distribute the query over one or more nodes based on the capabilities of the nodes.

23. The logic routing grid of claim 22, wherein at least one node of the one of more nodes to which processing of the query is distributed is connected to a subset of nodes such that processing and data are distributed across the subset of nodes.

24. The logic routing grid of claim 20, wherein the analyzer is further configured to select one or more nodes to process a query based on a set of call routing digits.

25. The logic routing grid of claim 20, wherein a capability of each node from a subset of the plurality of interconnected nodes specifies a logical connection among the subset of nodes.
